(19) United States
(12) Patent Application Publication
(10) Pub. No.: US 2023/0058608 A1
(43) Pub. Date: Feb. 23, 2023

(54) METHOD OF REDUCING CARBON EMISSIONS AND IMPROVING THE ENVIRONMENTAL PERFORMANCE OF CONCENTRATE PRODUCERS AND SMELTERS

(71) Applicant: WORLD RESOURCES COMPANY, Jackson, WY (US)

(72) Inventors: Peter T. Halpin, Moose, WY (US); Dale Schneck, Pottsville, PA (US); Ulrich R. Schlegel, Washington, DC (US)

(73) Assignee: WORLD RESOURCES COMPANY, Jackson, WY (US)

(21) Appl. No.: 17/975,764

(22) Filed: Oct. 28, 2022

Related U.S. Application Data
(63) Continuation of application No. PCT/US2021/055742, filed on Oct. 20, 2021.
(60) Provisional application No. 63/104,467, filed on Oct. 22, 2020.

(51) Int. Cl. C22B 1/244; C22B 15/00

(52) U.S. Cl. CPC C22B 1/244; C22B 15/0028

(57) ABSTRACT

A process which improves the environmental performance of primary non-ferrous metal smelters by reducing carbon emissions, providing enhanced energy utilization, improving consumption efficiencies, and improving worker safety. The smelters include those that smelt nickel, copper and zinc. The process includes a step of drying feedstock prior to the addition of a product conditioning solution that includes saccharides as a primary ingredient. Sucrose and fructose are preferred saccharides. A base saccharide solution may be prepared by either diluting a concentrated saccharide syrup (75 to 85 brix), or by dissolving a dried powdered saccharide in water to a concentration that yeilds a syrup of between 20 and 30 Brix, more preferentially 25 Brix. The Brix may be measured with any commercially available refractometer capable of measuring the Brix of sugar solutions.

### FIELD OF THE INVENTION

The technical field of the invention is the reduction of carbon emissions from industrial activities and processes, and thereby the reduction of global warming. The technical field of the invention is also the improvement of the environmental performance of industrial processes. The technical field of the invention is also the improvement of the financial evaluation of companies that carry out industrial processes, so that investors may be more confident that the companies can comply with increases in environmental restrictions and remain profitable. One environmental problem with smelters is carbon emissions which contribute to climate change. A method of reduction of these emissions by decreasing the consumption of fossil fuels during transport, smelting and associated environmental emissions capture equipment, improves environmental performance. The field of the invention particularly includes non-ferrous metal smelters, such as smelters of nickel, cobalt, copper and zinc, and improvement of their environmental performance.

### BACKGROUND OF THE INVENTION

Smelter inputs include intermediates. These intermediates are metallurgical process byproducts. They may include the same smelter's own slag as reverts (i.e. metal in the form of sprues, gates, runners, risers and scrapped castings, with known chemical composition that are returned to the furnace for remelting). They may also include metal-bearing slags acquired from other smelters, which may be referred to as external feeds or external inputs. These external feeds may be slags that require reprocessing because they still contain recoverable metals that were insufficiently or ineffectively smelted.

These intermediates may also include byproducts that are produced further down the process line, or that are produced downstream by metal refineries. These intermediates may include recovered dusts/materials from the treatment of air emission or from waste treatment processes internal to the metallurgical production supply chain.

These intermediates also include a class of concentrates referred to as secondary concentrates, because they are produced to the smelter specifications and are contractually specified inputs from external recycling feeds which are produced by various industries. These secondary concentrates are the finished products produced by recyclers of industrial metallurgical by-products as well as metal bearing metal finishing activities.

Intermediates are important components of both short and long term smelter operational planning and material management. There are local and global trading and processing markets for these intermediates, which may be generated from the operations of a mining company, or acquired from other mining companies as well as metal processors/producers.

Smelter inputs may also include enhanced feedstocks.

Smelters consume large volumes of these intermediates. This consumption may be regular, or irregular, depending upon market conditions or smelter needs. Thus, the metallurgical and handling characterisitics of these intermediates may have major impact on the transport and handling of these intermediates, efficiency of a smelter, and on the economic and environmental aspects of smelter operations.

### SUMMARY OF THE INVENTION

The present invention includes a process which improves the environmental performance of primary non-ferrous metal smelters by reducing carbon emissions, providing enhanced energy utilization, improving consumption efficiencies, and improving worker safety. The primary non-ferrous metal smelters include those that smelt nickel, copper and zinc.

The present invention includes a process that reduces the moisture level of the secondary concentrate feedstock for smelters, produces improved homogeneity of the feedstock of smelters, and enhances safety in smelting and related material handling. The material handling includes bedding, blending and compounding feedstocks. The process of the present invention
(1) reduces energy consumption;
(2) creates additional capacity utilization;
(3) enables additional recycling of feedstocks, of material from industry and fluxes to be smelted thereby, increasing metal production;
(4) enables the enhanced feedstocks to be introduced at multiple points in the smelting process and enhances operational efficiency and flexibility;
(5) enables the enhanced feedstocks to be more efficiently introduced into the smelting process by additional mixing and/or blending with feedstocks before the final smelting steps;
(6) enhances the homogeneity of feedstocks thereby producing new operational and energy consumption efficiencies;
(7) enhances sampling efficiencies thereby producing improved metal recovery accountability process efficiencies;
(8) reduces significantly the fugitive dust emissions and enhances worker safety in material handling, improves metal recovery accountability, and improves operational and quality control; and
(9) enhances and increases operational efficiencies for energy and metal recovery throughout the supply chain, including (a) an increase in recycling operational capacities and (b) a reduction in energy consumption in the logistics chain from recycling production facilities of secondary concentrates to primary smelters.

The present invention includes a step of drying feedstock prior to the addition of a product conditioning solution. For example, in the case of metal hydroxide materials, the material may be dried to a moisture content of between 50 to 90% solids (50% to 10% moisture), and preferentially between 60% to 90% solids (40% to 10% moisture). The desired moisture content depends in part on the smelter product specification.

The product conditioning solution includes saccharides as a primary ingredient. Saccharides are also commonly known as sugars. They are available as a number of compounds such as fructose, maltose, sucrose, galactose, dextrose, etc. Any readily available saccharide may be utilized in the processes of the present invention. However, sucrose and fructose are usually preferred, and sucrose is normally the more preferred. Saccharides in solution tend to exhibit a sticky and adhesive quality which promotes the agglomeration of fine dried particles into larger particles less capable of becoming airborne. Upon drying, the saccharides will form a crystalline structure, retaining the agglomeration and dust suppression of the product particles.

### BRIEF DESCRIPTION OF THE DRAWING

FIG. 1 is schematic representation of an embodiment of the invention for a nickel smelter.

FIG. 2 is schematic representation of an embodiment of the invention for a copper smelter.

FIG. 3 is schematic representation of savings according to an embodiment of the invention.

### DETAILED DESCRIPTION OF THE INVENTION

In an embodiment of the invention, a base saccharide solution is prepared by either diluting a concentrated saccharide syrup (75 to 85 brix), or by dissolving a dried powdered saccharide in water to a concentration that yeilds a syrup of between 20 and 30 Brix, more preferentially 25 Brix. The Brix may be measured with any commercially available refractometer capable of measuring the Brix of sugar solutions, such as the Milwaukee MA 871 Digital Brix Refractometer.

In an embodiment of the invention, a base saccharide solution is alternately prepared by either diluting a concentrated saccharide syrup (75 to 85 brix), or by dissolving a dried powdered saccharide in metal-bearing spent plating solutions or other non-ferrous metal bearing solutions. This increases the overall metal content of metal-bearing nonferrous concentrate and minimizes the amount of water necessary to adjust the Brix of saccharide ingredient, while also reducing the total amount of saccharide required to achieve the desired Brix concentration of the product conditioning solution (metal-bearing spent plating solutions may exhibit a starting Brix concentration of approximately 10 compared to water at a Brix of 0). In addition, this improves the finished Concentrate product by helping to reduce the amount of entrained moisture while simultaneously yielding a more granulated and dust free product.

In an embodiment of the invention, the dispersion of product conditioning solution into the dried feedstock material is enhanced by the addition of a surfactant, preferably an anionic/neutral surfactant. A surfactant has been found to be effective at concentrations ranging between 0.25% to 1% by volume, and more preferentially at a 0.5% concentration.

In an embodiment of the invention, a biocide and/or fungicide is added to the product conditioning solution, so as to reduce or eliminate the potential of bacteria growth and/or mold if the solution or final treated feedstock is stored for prolonged periods of time. Various biocides/fungicides are available with sorbic acid or potassium sorbate being preferred. Potassium sorbate is more preferred due to its high solubility in aqueous solutions and effectiveness at low concentrations, preferably between 0.02% and 0.10%, and more preferentially at 0.025%.

In an embodiment of the invention, metal hydroxide feedstock materials or other types of materials discharging from a dryer, including mechanical dryers or solar drying receptacles, are agglomerated with the product conditioning solution by using any of several types of continuous blenders and mechanical bulk batch mixing devices where the product conditioning solution is injected into the product by means of an adjustable feed pumping mechanism. Mixing and agglomerating the dried product with the product conditioning solution is achieved by the mechanical action resulting in a granular, dust free, homogeneous, and free flowing final product.

In an embodiment of the invention, the application of the product conditioning solution is adjusted to achieve a dust free final product during discharge into bulk intermediate containers or from bulk handling equipment activities loading railcars or sea containers. The application rate of the product conditioning solution may vary greatly depending on the individual feedstock physical and chemical properties, however the application rate will preferably be between 5 gallons and 40 gallons per short ton (2000 pounds), and more preferably between 10 gallons and 15 gallons per short ton of dried product.

It will be apparent to those skilled in the art that various changes and modifications may be made to the invention as described herein without departing from the spirit of the invention.

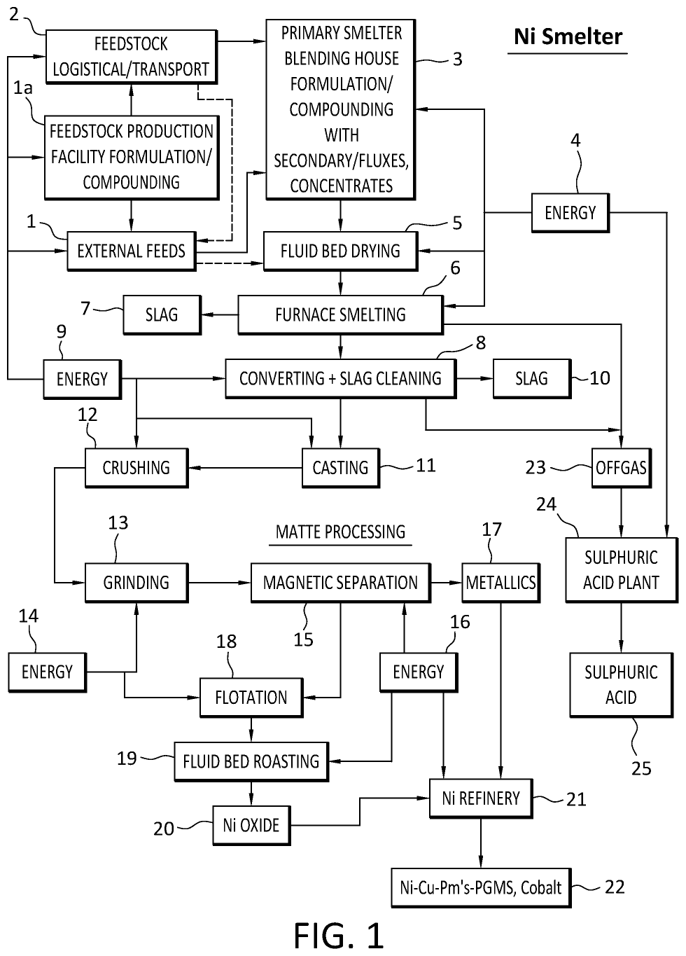

FIG. 1 shows an embodiment of a method according the present invention for a nickel smelter. External Feeds 1, which may include intermediates or a feedstock production facility 1 (a) prepares the feedstock, or a custom feedstock, by formulation and compounding, are entered into the Primary Smelter Blending House, formulation/compounding with secondaries/fluxes, concentrates 3 which receives energy from source 4 via Feedstock Logistical/Transport 2, which receives energy from energy source 9. The output of Primary Smelter Blending House 3 is fed to fluid bed drying apparatus 5, which receives energy from energy source 4. The output from pressure filtration apparatus 3 is fed to furnace smelting apparatus 6. The output from furnace smelting apparatus 6 is fed to an apparatus for converting and cleaning slag 8, which receive energy from energy source 9. The output from furnace and other smelting furnace design smelting apparatus 6 may also include slag for disposal 7. The output from the apparatus for converting and cleaning slag 8 may be slag for disposal 10, or fed to casting apparatus 11, which may receive energy from energy sources 9. The output from casting apparatus 11 may be fed to crushing apparatus 12, which may receive energy from energy source 9. The output from crushing apparatus 12 may be fed to grinding apparatus 13, which may receive energy from energy source 14.

The output from grinding apparatus 13 may be fed to magnetic separation apparatus 15 as part of matte processing. Magnetic separation apparatus 15 may receive energy from energy source 16. The output from magnetic separation apparatus 15 may include metallics 17, and non-metallics. The non-metallics may be fed to flotation apparatus 18, which may receive energy from energy source 14. The output from flotation apparatus 18 may be fed to fluid bed roasting apparatus 19. The output from fluid bed roasting apparatus may be nickel oxide 20.

Nickel refinery 21 may receive the nickel oxide 20 as well as the metallics, and produce metals 22 such as nickel, copper, precious metals, platinum group metals, and cobalt.

The furnace and other smelting furnace design smelting apparatus 6 and the apparatus for converting and cleaning slag 8, may produce off-gas 23, which may be fed to a sulfuric acid plant 24, which may produce sulfuric acid 25.

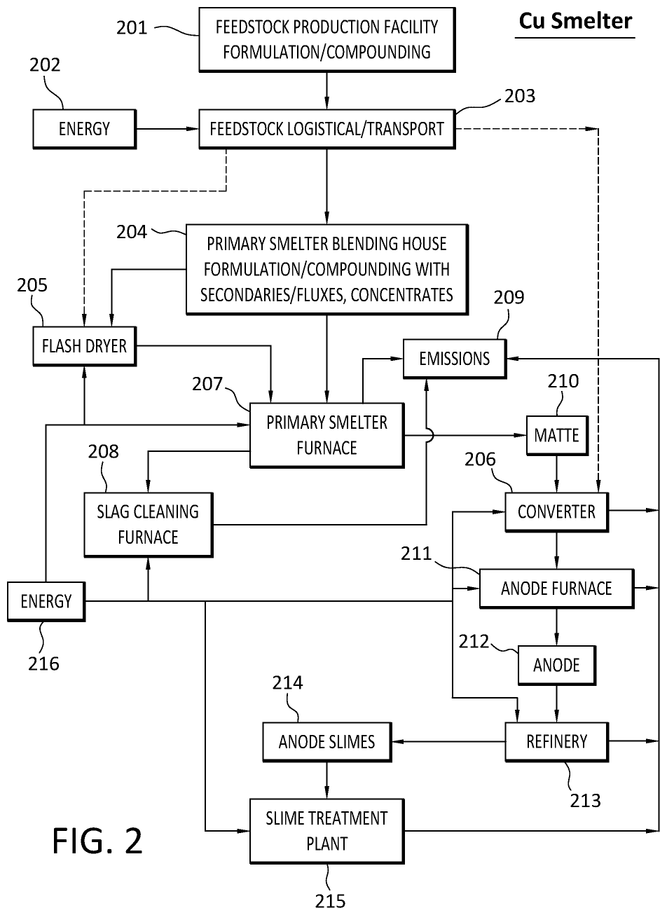

FIG. 2 shows an embodiment of a method according the present invention for a copper smelter. A feedstock production facility 201 prepares the feedstock, or a custom feedstock, by formulation and compounding. Energy from energy source 202 is used in preparing the feedstock, and in transporting 203 the feedstock to the primary smelter blending house 204 where there may be additional formulation and compounding with secondaries, fluxes and/or concentrates. The transporting 203 may also be to flash dryer 205, and/or to converter 206. The primary smelter blending house 204 may output to flash dryer 205 and/or to primary smelter furnace 207.

The primary smelter furnace and other smelting furnace design smelting apparatus 207 may output to the slag cleaning furnace 208. Both the primary smelter furnace and other smelting furnace design smelting apparatus 207 and the slag cleaning furnace 208 may output to emissions 209. The primary smelter furnace and other smelting furnace design smelting apparatus 207 may output to the matte 210, which outputs to the converter 206. The converter 206 may output to emissions 209 and/or to anode furnace 211. The anode furnace 211 may output to emissions 209 and/or to anode 212. The anode 212 outputs to the refinery 213. The refinery 213 may output to emissions 209 and/or to anode slimes 214. The anode slimes 214 may output to the slime treatment plant 215. The slime treatment plant 215 may output to emissions 209. Energy from energy source 216 may be provided to flash dryer 205, primary smelter furnace and other smelting furnace design smelting apparatus 207, slag cleaning furnace 208, converter 206, anode furnace 211, refinery 213, and slime treatment plant 215.

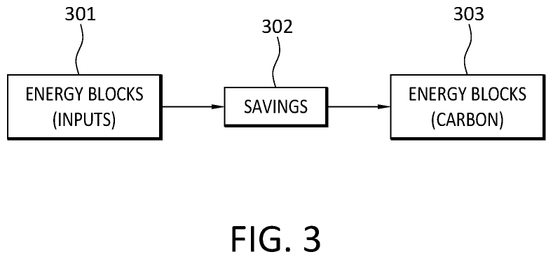

FIG. 3 is schematic representation of savings according to an embodiment of the invention. The energy blocks 301 result in savings 302 and emission blocks 303.

1. A process of reducing carbon emissions and improving environmental performance of a smelter, the process comprising a step of feeding a feedstock into the smelter, wherein the feedstock comprises a saccharide.

2. The process of claim 1, wherein the saccharide may include one or more saccharides such as fructose, maltose, sucrose, galactose, and dextrose.

3. The process of claim 1, wherein the feedstock further comprises a surfactant.

4. A process of preparing a feedstock for a non-ferrous metal smelter, the process comprising a step of mixing a saccharide with a non-ferrous metal compound.

5. The process of claim 4, wherein the saccharide is selected from fructose, maltose, sucrose, galactose, dextrose and/or other saccharides.

6. The process of claim 4, further comprising a step of mixing a surfactant with the saccharide and the non-ferrous metal compound.

7. The process of claim 4, wherein the saccharide is in water at a concentration of between 20 and 30 Brix.

8. The process of claim 4, wherein the saccharide is alternately in a metal-bearing spent plating solution or other non-ferrous metal bearing solution at a concentration of between 20 and 30 Brix.

9. A feedstock for a non-ferrous metal smelter, wherein the feedstock comprises a saccharide and a non-ferrous metal compound.

10. The feedstock of claim 9, wherein the selected saccharide(s) is one or more saccharides such as fructose, maltose, sucrose, galactose, and dextrose.

11. The feedstock of claim 9, further comprising a surfactant.

12. The process of claim 1, wherein the feedstock further comprises a fungicide, a biocide, or both a fungicide and a biocide.

13. The process of claim 4, further comprising a step of mixing the saccharide and the non-ferrous metal compound with a fungicide, a biocide, or both a fungicide and a biocide.

14. The feedstock of claim 9, further comprising a fungicide, a biocide, or both a fungicide and a biocide.

15. A process of reducing a moisture level of a feedstock for a smelter, producing an improved homogeneity of the feedstock of the smelter, and enhancing safety in smelting and related material handling, wherein the feedstock comprises a saccharide.
